(19) United States
(12) Patent Application Publication
(10) Pub. No.: US 2008/0030756 A1
(43) Pub. Date: Feb. 7, 2008

(54) PRINT JOB ELIGIBILITY BASED ON NAMED SNAPSHOTS OF PRINTER SETTINGS

(76) Inventors: Dennis M. Carney, Louisville, CO (US); Allan A. Hren, Longmont, CO (US)

Correspondence Address: DUFT BORNSEN & FISHMAN, LLP, 1526 SPRUCE STREET, SUITE 302, BOULDER, CO, 80302, US

(21) Appl. No.: 11/460,566

(22) Filed: Jul. 27, 2006

(51) Int. Cl. G06F 3/12

(52) U.S. Cl. 358/1.13

(57) ABSTRACT

Systems and methods are provided to permit printing systems to determine flexible job eligibility for print jobs based on named snapshots of printer settings. In one aspect hereof, the printing system provides at least one snapshot, each snapshot including at least one printer setting for operating a printer, and determines eligibility for printing a print job based on at least one printer setting in a snapshot associated with the print job and based on at least one current operating parameter of the printer. Printer settings in the snapshot may be specified as required or not required for job eligibility. The print job is released for printing responsive to determining that the print job is eligible to be printed on the printer.

### BACKGROUND

1. Field of the Invention

The invention is related to the field of printing systems, and in particular, to methods and systems for determining print job eligibility based on named snapshots of printer settings.

2. Discussion of Related Art

Printers may have a plurality of operating points, which can be modified by changing the printer settings. Printer settings may be categorized as, for example, form settings, printer definitions, print quality, and print registration. Form settings may include physical paper size, weight, color, etc. Printer definitions may include IPDS resolution, off-set stacked enabled, etc. Print quality may include contrast, boldness, oil rate, fuser temperature, etc. Print registration may include X and Y incremental adjustments of the printer to position images imprinted thereon. These and numerous other printer settings may be stored in a named printer container, also known as a “snapshot”. The snapshot provides a printer operator a way to quickly change the operating point of a printer by changing the printer settings. The user sets the operating point of a printer and saves that operating point by selected name. The next time a job needs to be printed at a certain printer operating point, the sender of the job notifies the printer operator of the upcoming job, and the operator selects the correct snapshot, and the job is printed at the correct printer operating point.

A print job received by a printer usually has one or more physical resource requirements, some of which may not be available to complete the print job. For example, a particular paper media type needed by the print job may not be available. The print job is held by the printer awaiting an operator action (e.g., loading the necessary paper media type). Once the resource needed by the printer is made available, the printer may complete the print job.

In systems where the printer processes a plurality of print jobs from a queue in the order the print jobs were received, the lack of resources may become a problem for the printing operator. Assume for example that a printer first receives a print job requiring legal sized paper and additionally receives nine more print jobs requiring letter sized paper. Assume further that the printer does not have any legal sized paper loaded in a paper tray. If the printer processes print jobs in a first in first out manner, then all ten print jobs will be held up until the printer operator takes action and loads legal sized paper into the printer. The printer will then be idle and unproductive. This unproductive time may be a problem for heavily used printers where the operator cannot afford significant downtime.

Job eligibility attempts to prevent or limit the times when a printer is nonproductive, waiting for manual interventions because of print job and printer physical resource mismatches. Job eligibility allows a printer to hold an ineligible print job in a queue awaiting operator action, while printing other print jobs where the printer has the necessary resources to complete the eligible print jobs. In the previously described example, a job eligibility solution would allow the printer to hold the legal sized paper print job, and complete the nine letter sized paper print jobs. When the operator returns to the printer, there would only be one uncompleted print job remaining rather then ten uncompleted print jobs.

Job eligibility as presently practiced is based on consumables such as physical media size or type and toner supply. Consumables based job eligibility relies on all of the eligibility criteria to be explicitly called out in the print job, by physical media size or type, or to be derivable from the job, such as toner requirements. There is currently no method for incorporating printer operating settings relating to print quality adjustments and print registration into eligibility criteria. One method for incorporating printer operating point settings into eligibility criteria could be to define each setting as a job parameter. This method is undesirable because operating points can very between print engines of the same type, which means that if operating point settings were defined in a print job and used to determine job eligibility, a particular job would most likely run on one specific print engine. If at least one of the specified printer settings with the job is not matched by the current operating parameters of the printer, then the job is held until a printer operator intervention. Jobs may be unnecessarily stopped awaiting operator invention, and the printer may be idle and unproductive during this time. For example, if a printer stops awaiting printer operator intervention while the printer operator is at lunch, a significant amount of printer time may be wasted. Thus, a solution to job eligibility is needed to efficiently match print jobs with the resources of a printer.

### SUMMARY

The invention solves the above and other related problems with methods and associated systems and apparatus operable to permit printing systems to determine job eligibility for print jobs based on named snapshots of printer settings. A print job may specify a snapshot indicating a group of printer settings to be used for printing the job, and further indicating whether a particular printer setting must be used for determining the eligibility of the print job to print on the printer. Thus, the features and aspects hereof provide flexibility to printers to efficiently match print jobs with the available resources of a printer.

Using the features and aspects hereof, printer users may send a print job to the printer with flexible criteria for the operating point of the printer, indicating both required and desirable printer settings. A snapshot may now specify that the print job be held unless a particular printer setting currently matches the operating point of the printer. Conversely, the snapshot may also specify that the print job not be held if a non-critical printer setting does not match the operating point of the printer. For example, a user may specify a particular snapshot for a print job indicating that the job should print on beige letter sized paper. However, the user may be willing to accept the job printed on any color letter sized paper. In the described example, the color is a desirable but non-critical printer setting, but the paper size is a critical setting. Assume for example that beige letter sized paper is unavailable, but white letter sized paper is available in the printer. Previously, the job may have been held until beige letter sized paper became available through operator intervention. However, if the user sends the print job to a printer using features and aspects provided herein, the job would be printed because the paper color as specified is a non-critical printer setting. Assuming that all critical printer settings specified in the snapshot were available, the job eligibility checker would release the print job for printing.

One feature hereof provides a method for operating a printing system. The method comprises providing at least one snapshot, each snapshot including at least one printer setting for operating a printer. The method further comprises associating a snapshot with a print job based on information in the print job.

Another feature hereof provides an apparatus in a printing system that comprises at least one snapshot, each snapshot including at least one printer setting for operating a printer. The apparatus further comprises a job eligibility checker communicatively coupled with at least one snapshot and adapted to determine eligibility for printing a print job based on at least one printer setting in a snapshot associated with the print job and based on at least one current operating parameter of the printer. The job eligibility checker is further adapted to release the print job for printing responsive to determining that the print job is eligible to be printed on the printer.

Another feature hereof provides a method for operating a printing system. The method comprises providing at least one snapshot, each snapshot including at least one printer setting for operating a printer. The method further comprises determining eligibility for printing a print job based on at least one printer setting in a snapshot associated with the print job and based on at least one current operating parameter of the printer. The method further comprises releasing the print job for printing responsive to determining that the print job is eligible to be printed on the printer.

The invention may include other exemplary embodiments described below.

### BRIEF DESCRIPTION OF THE DRAWINGS

The same reference number represents the same element on all drawings.

FIG. 1 is a block diagram of an exemplary apparatus of a printing system enhanced in accordance with features and aspects hereof.

FIG. 2 is a flowchart of an exemplary method in accordance with features and aspects hereof operable in a printing system to permit print job eligibility based on named snapshots of printer settings.

FIG. 3 is a block diagram of another exemplary apparatus of a printing system enhanced in accordance with features and aspects hereof.

FIG. 4 is a flowchart of another exemplary method in accordance with features and aspects hereof operable in a printing system to permit print job eligibility based on named snapshots of printer settings.

FIG. 5 is a flowchart of another exemplary method in accordance with features and aspects hereof operable in a printing system to permit print job eligibility based on named snapshots of printer settings.

FIG. 6 is a flowchart of another exemplary method in accordance with features and aspects hereof operable in a printing system to permit print job eligibility based on named snapshots of printer settings.

FIG. 7 is a flowchart of another exemplary method in accordance with features and aspects hereof operable in a printing system to permit print job eligibility based on named snapshots of printer settings.

FIG. 8 is a block diagram of an exemplary data processing system that may provide printing features and aspects hereof including print job eligibility based on named snapshots of printer settings.

FIG. 9 is a flowchart of another exemplary method in accordance with features and aspects hereof operable in a printing system to permit associating a snapshot with a print job.

### DETAILED DESCRIPTION

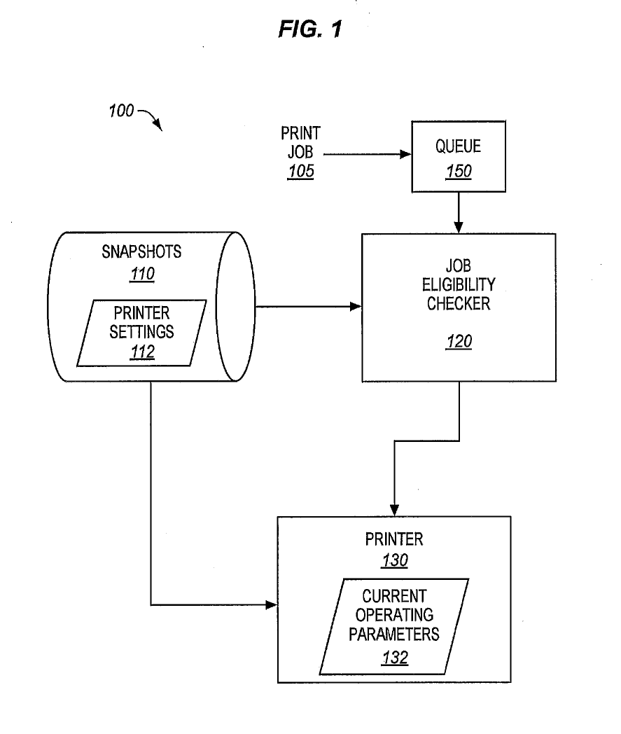

FIGS. 1-9 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

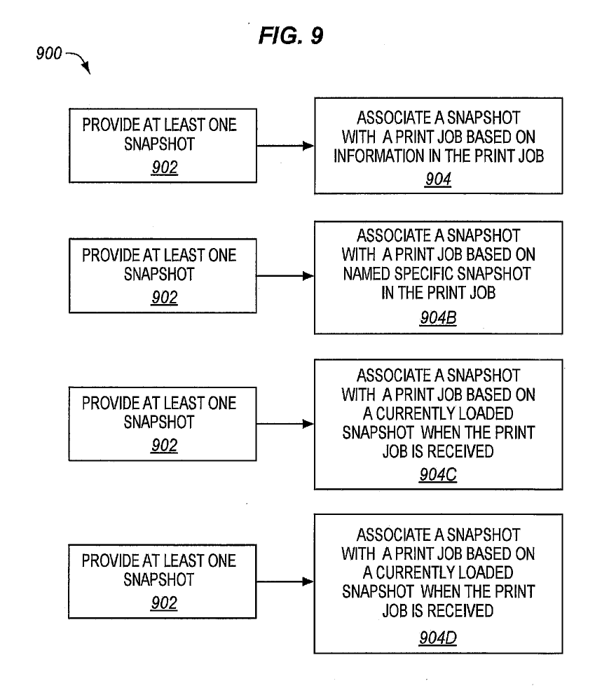

FIG. 9 illustrates a method 900 for operating a printing system that allows a print job to be associated with a snapshot of specified printer settings of a printer. The snapshot associated with the print job allows a printer operator to specify printer settings with the print job, and print the print job to the specified printer settings. The steps of the flow chart in FIG. 9 are not all inclusive and may include other steps not shown.

In step 902, the printing system provides at least one snapshot, each snapshot including at least one printer setting for operating a printer. The snapshots may already be stored in memory, may be provided by a printer operator, may be provided with the print job, etc.

In step 904, the printing system associates a snapshot with a print job based on information in the print job. Based on the information in the print job, the print job may be ripped and/or printed to the printer settings in the print job. Ripping involves rasterizing the print job to convert the print job into a bitmap format for printing. Further, the snapshot may be captured for later restoration and use by other print jobs. Should the print job be ripped to a specified snapshot but not be printed before the loaded snapshot on the printer changes, the associated snapshot with the print job may be used to restore the specified printer settings needed for the print job to print.

The associated snapshot with the print job may alternatively be specifically named in the print job. In step 904B, the associating step may further comprise determining the snapshot associated with the print job based on a named specific snapshot in the information in the print job. For example, a print job may comprise the payroll for a company, and a snapshot “Payroll” may be stored on the printer specifying the printer settings desired for payroll jobs. The print job may be received by the printing system and designate the “Payroll” snapshot for the print job. A printer operator may then load the “Payroll” snapshot on the printer before printing the print job.

Alternatively, the associated snapshot with the print job may be determined by the snapshot presently loaded on the printer when the print job is received. In step 904C, the associating step may further comprise determining the snapshot associated with the print job based on a specific snapshot presently loaded on the printer at the time the print job is received by the printer. For example, a print job may not specify an associated snapshot when received by the printing system. However, a snapshot may be presently loaded on the printer when the print job is received. The printing system may associate the presently loaded snapshot on the printer with the print job when the print job is received. The associated snapshot with the print job may specify the printer settings to print the print job, allowing the printer operator to restore the printer settings later to print the print job should the snapshot loaded on the printer change before the print job is printed.

Alternatively, the associated snapshot with the print job may be determined by the snapshot presently loaded on the printer when the print job is ripped. In step 904C, the associating step may further comprise determining the snapshot associated with the print job based on a specific snapshot presently loaded on the printer at the time the print job is ripped by the printer. For example, a print job may not specify an associated snapshot when the print job is ripped by the printing system. However, a snapshot may be presently loaded on the printer when the print job is ripped. The printing system may associate the presently loaded snapshot on the printer with the print job when the print job is ripped. The associated snapshot with the print job may specify the printer settings to print the print job, allowing the printer operator to restore the printer settings later to print the print job should the snapshot loaded on the printer change before the print job is ripped.

In addition to specifying the printer settings for printing a print job, a snapshot may also be used to determine job eligibility for printing a print job, as described below.

FIG. 1 illustrates an exemplary printing system 100 for receiving print jobs from one or more host systems (not shown) and for imprinting the print jobs on appropriate printable medium. Printing system 100 includes at least one snapshot 110. Each snapshot 110 includes at least one printer setting 112 for operating a printer 130. The snapshot 110 is provided to save a specified operating point of the printer 130 and the corresponding printer settings 112. This allows an operator to change the current operating parameters 132 of the printer to match the printer settings 112 of the snapshot 110. A snapshot 110 associated with a print job 105 may also specify the printer settings 112 for printing the print job 105. The printer 130 further comprises current operating parameters 132 specifying the operating point and printer settings 112 of the printer 130 for the snapshot 110 presently loaded onto the printer 130.

The printing system 100 includes a queue 150 for storing received print jobs. The printing system 100 also includes a job eligibility checker 120 communicatively coupled with at least one snapshot 110. The job eligibility checker 120 is adapted to determine eligibility for printing a print job 105 based on at least one printer setting 112 in a snapshot 110 associated with the print job 105 and based on at least one current operating parameter 132 of the printer 130. The job eligibility checker 120 is further adapted to release the print job 105 to the printer 130 for printing responsive to determining that the print job 105 is eligible to be printed on the printer 130.

The snapshot 110 associated with the print job 105 may be embedded in the page description languages (PDL) and/or print job languages (PDL) used for encoding raw print jobs. A print job 105 may be ripped to the printer settings 112 in the snapshot 110. For example, these may include paper size, N-up layout, etc.

The job eligibility checker 120 may determine that because the current operating parameters 132 of the printer 130 do not match the printer settings 112 of the snapshot associated with the print job 105, that the print job 105 may not be eligible to print. For example, the snapshot 110 may comprise a printer setting 112 indicating that the print job 105 is to print on a specified paper size. If the specified paper size is not loaded into the printer 130, the job eligibility checker 120 may determine that the print job 105 is not eligible to print.

For example, if a print job 105 is determined to be ineligible to print, the print job 105 may be held until the current operating parameters 132 of the printer are changed to match the snapshot 110. The job eligibility checker 120 may be configured to periodically re-check a print job 105 being held in an ineligible queue 150 to determine if the print job 105 is now eligible to print. Alternatively, the job eligibility checker 120 may be configured to re-check the print job 105 being held in the ineligible queue 150 to determine if the print job 105 is now eligible to print once the current operating parameters 132 of the printer 130 change. The job eligibility checker 120 may also be configured to change the current operating parameters 132 of the printer 130 to match the relevant printer settings 112 of the snapshot 110, and allow the print job 105 to be eligible to print.

A print job 105 may be held in the ineligible queue 150 until the printer settings 112 become available in the current operating parameters 132 of the printer 130. The print job 105 may be held as a raw print job, and may be ripped when the job eligibility checker 120 determines that the print job 105 becomes eligible to print. In an alternate embodiment, an ineligible print job 105 may not be released to the printer 130 for printing, but the print job 105 may still be ripped, with the output bitmaps of the print job 105 stored in the queue 150, awaiting the loading of the specified printer settings 112 of the snapshot 110 associated with the print job 105. This allows improved printer 130 through-put by taking advantage of spare processing cycles while other print jobs are printing.

Those of ordinary skill in the art will readily recognize a variety of additional features and functions useful or required within a fully operational printing system 100. Such additional functions and features are omitted herein simply for brevity of this description. Still further, the functional elements shown in FIG. 1 are intended merely as one possible functional decomposition of elements within the printing system 100. Those of ordinary skill in the art will recognize other functional decompositions of the functions therein providing either higher integration or more separation of the various functional elements. Still further as noted above, the various functional elements depicted within the printing system 100 may be implemented either totally as suitably programmed instructions in a general or special purpose executed by a general or special purpose processor within the printing system 100, may be implemented solely as custom designed circuitry for performing such functions, or may be implemented as a combination of custom designed circuits and suitably programmed instructions executed by a general or special purpose processor within the printing system 100. In particular, the job eligibility checker 120 may be implemented as a combination of simpler custom design circuits operable in combination with suitably programmed instructions executed by a general or special purpose processor within the printing system 100.

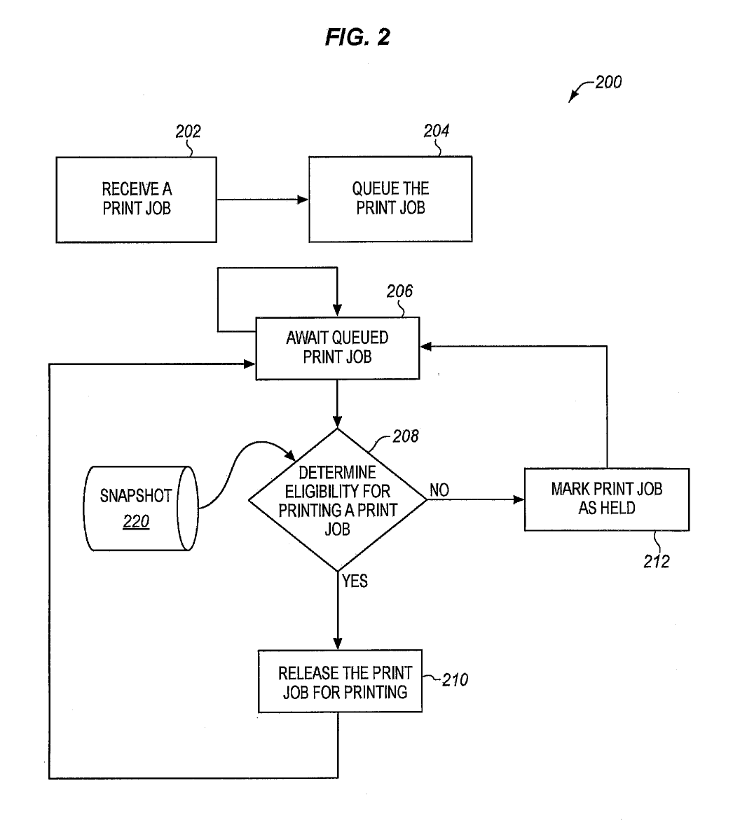

FIG. 2 is a flow chart illustrating an exemplary method 200 for operating a printing system. The steps of the flow chart in FIG. 2 are not all inclusive and may include other steps not shown.

The printing system is provided with at least one snapshot 220, each snapshot 220 including at least one printer setting for operating a printer. The snapshots 220 may already be stored in memory, may be provided by a printer operator, may be provided with the print job, etc.

In step 202, the printing system receives a print job. In step 204, the printing system queues the print job. Those of ordinary skill in the art will readily recognize a variety of techniques are available for receiving a print job and placing the print job in a queue.

In step 206, an asynchronous process on the print system awaits a queued print job. A queued print job may comprise a newly received print job, or a previously held print job in the queue, etc.

In step 208, the printing system determines eligibility for printing the print job based on at least one printer setting in a snapshot 220 associated with the print job and based on at least one current operating parameter of the printer. To determine eligibility of the print job to print, the printer settings of the snapshot 220 may be considered. The print job may be determined ineligible to print if at least one of the printer settings does not match the current operating parameters of the printer. Otherwise, if the current operating parameters of the printer match the printer settings of the snapshot 220, then the print job may be printed.

In step 210, if the print job is determined eligible to print, then the print job is released for printing. In step 212, if the print job is determined ineligible to print, then the print job is marked as held in the queue. If the print job is determined ineligible to print because at least one printer setting specified as relevant to determining eligibility in the snapshot associated with the print job, then the print job is held until the print job becomes eligible to print. Ineligible print jobs may periodically be re-evaluated to determine whether the print job has become eligible to print based on a change of the current operating parameters of the printer.

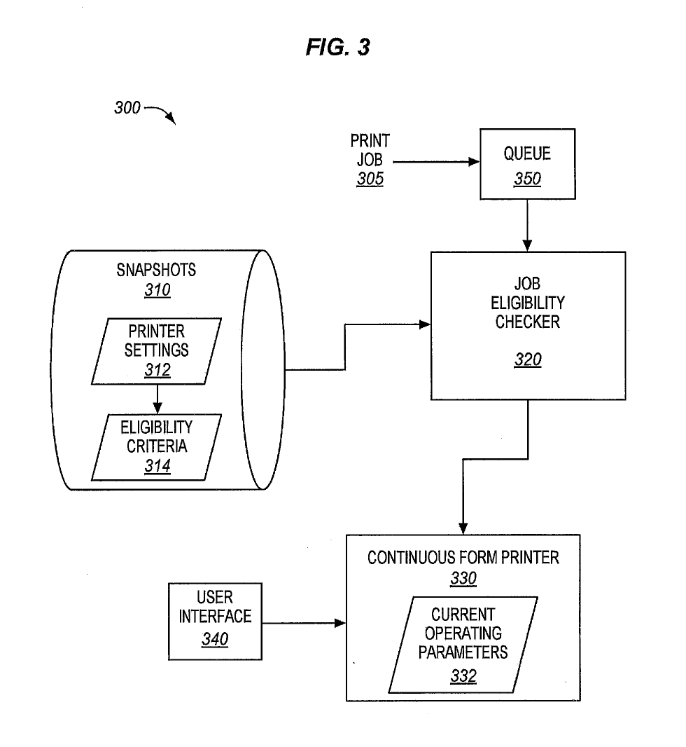

FIG. 3 illustrates an exemplary printing system 300 for receiving print jobs from one or more host systems (not shown) and for imprinting the print jobs on appropriate printable medium. The printing system 300 includes at least one snapshot 310. Each snapshot 310 includes at least one printer setting 312 for operating a continuous form printer 330. Each printer setting 312 may further comprise eligibility criteria 314. The eligibility criteria 314 indicate which of the printer settings 312 is relevant to determining the eligibility to print the print job 305 associated with the snapshot 310. The continuous form printer 330 further comprises current operating parameters 332 specifying the operating point and printer settings 312 of the continuous form printer 330 for the snapshot 310 presently loaded onto the continuous form printer 330.

Printing system 300 also includes a job eligibility checker 320 communicatively coupled with at least one snapshot 310. The job eligibility checker 320 is adapted to determine eligibility for printing a print job 305 based on at least one printer setting 312 in a snapshot 310 associated with the print job 305 and on at least one current operating parameter 332 of the continuous form printer 330. The job eligibility checker 320 is further adapted to release the print job 305 to the continuous form printer 330 for printing responsive to determining that the print job 305 is eligible to be printed on the continuous form printer 330.

The printing system 300 further comprises a queue 350 for storing print jobs. The queue 350 may receive a print job 305 and store the print job 305 until the print job 305 is eligible to print and is released to the continuous form printer 330.

The printing system 300 further comprises a user interface 340 communicatively coupled with the job eligibility checker 320. The user interface 340 may be adapted to allow a printer operator to manually release the print job 305 to the continuous form printer 330 for printing. The user interface 340 may further be adapted to allow the printer operator to change at least one current operating parameter 332 of the continuous form printer 330.

The print job 305 may identify a snapshot 310 to be used by the job eligibility checker 320 to determine that the print job 305 is eligible to be printed on the continuous form printer 330. The printer settings 312 in a snapshot 310 may be configured to have an influence on the eligibility of the print job 305. For example, each printer setting 312 of the snapshot 310 may have corresponding eligibility criteria 314, which may be a Boolean value. The eligibility criteria 314 may specify whether the printer setting 312 is relevant to determining eligibility for printing of the print job 305. A printer setting 312 that is critical to the print job 305, such as a paper size, may have the Boolean value of eligibility criteria 314 for the printer setting 312 set to true. This may mean that the particular current operating parameters 332 of the printer must match the printer setting 312 (i.e., that paper size is available in the printer) of the snapshot 310 associated with the print job 305. The job eligibility checker 320 may determine that because the current operating parameters 332 of the continuous form printer 330 do not match the relevant printer setting 312 of the snapshot associated with the print job 305, that the print job 305 may not be eligible to print. For example, the snapshot 310 may comprise a printer setting 312 indicating that the print job 305 is to print on 11″ by 18″ sized paper. The eligibility criteria 314 may be set to true for that printer setting 312. If 11″ by 18″ sized paper is not loaded into the continuous form printer 330, the job eligibility checker 320 may determine that the print job 305 is not eligible to print.

On the other hand, a printer setting 312 may designate a non-critical state for the current operating parameters 332 of the printer. This may indicate that the print job 305 is desired to print with the designated printer setting 312, but the user may be unwilling to allow the print job 305 to be held if the printer setting 312 is not matched in the current operating parameters 332. In this case, the eligibility criteria 314 for the printer setting 312 may be set to false. If the current operating parameters 332 of the continuous form printer 330 do not match the printer setting 312 of the snapshot 310, the job eligibility checker 320 will determine that the print job 305 is eligible to print, because the specified printer setting 312 is indicated as not affecting the eligibility of the print job 305. For example, the snapshot 310 may comprise a printer setting 312 indicating that the print job 305 is to print on heavy paper. The eligibility criteria 314 may be set to false for that printer setting 312, indicating that the printer setting 312 is not relevant to determining eligibility to print. If heavy paper is not loaded into the continuous form printer 330, then the job eligibility checker 320 may determine that the print job 305 is eligible to print, and the print job 305 may be released to the continuous form printer 330 for printing.

If a print job 305 is determined to be ineligible to print, the print job 305 may be held until the current operating parameters 332 of the printer are changed to match the snapshot 310 associated with the print job 305. The job eligibility checker 320 may be configured to periodically re-check the print job 305 being held in the ineligible queue 350 to determine if the print job 305 is now eligible to print. Alternatively, the job eligibility checker 320 may be configured to re-check the print job 305 being held in the ineligible queue 350 to determine if the print job 305 is now eligible to print once the current operating parameters 332 of the continuous form printer 330 change. The job eligibility checker 320 may also be configured to change the current operating parameters 332 of the continuous form printer 330 to match the relevant printer settings 312 of the snapshot 310 and allow the print job 305 to be eligible to print.

A print job 305 may be held in the ineligible queue 350 until the relevant printer settings 312 become available in the current operating parameters 332 of the continuous form printer 330. The print job 305 may be held as a raw print job 305, and may be ripped when the job eligibility checker 320 determines that the print job 305 becomes eligible to print.

If the print job 305 does not specify an associated snapshot 310, then the printing system 300 may automatically set the associated snapshot 310 for the print job 305 to a predetermined snapshot 310. For example, the predetermined snapshot 310 may correspond to the current operating parameters 332 of the continuous form printer 330 (e.g., the current snapshot loaded in printer 330). The predetermined snapshot 310 may also correspond to a default snapshot 310 of the continuous form printer 330, or may correspond to another snapshot 310 captured by the printer operator for later restoration. The current operating parameters 332 of the continuous form printer 330 may be automatically changed to match the printer settings 312 in the snapshot 310 associated with the print job 305 received by the printing system 305. The printer settings 312 for operating the continuous form printer 330 may include form settings, printer definitions, print quality, and print registration. The printer settings 312 for operating the continuous form printer 330 may further include physical paper size, physical paper weight, media type, IPDS resolution, contrast, boldness, oil rate and fuser temperature.

Those of ordinary skill in the art will readily recognize a variety of additional features and functions useful or required within a fully operational printing system 300. Such additional functions and features are omitted herein simply for brevity of this description. Still further, the functional elements shown in FIG. 3 are intended merely as one possible functional decomposition of elements within the printing system 300. Those of ordinary skill in the art will recognize other functional decompositions of the functions therein providing either higher integration or more separation of the various functional elements. Still further as noted above, the various functional elements depicted within the printing system 300 may be implemented either totally as suitably programmed instructions in a general or special purpose executed by a general or special purpose processor within the printing system 300, may be implemented solely as custom designed circuitry for performing such functions, or may be implemented as a combination of custom designed circuits and suitably programmed instructions executed by a general or special purpose processor within the printing system 300. In particular, the job eligibility checker 320 may be implemented as a combination of simpler custom design circuits operable in combination with suitably programmed instructions executed by a general or special purpose processor within the printing system 300.

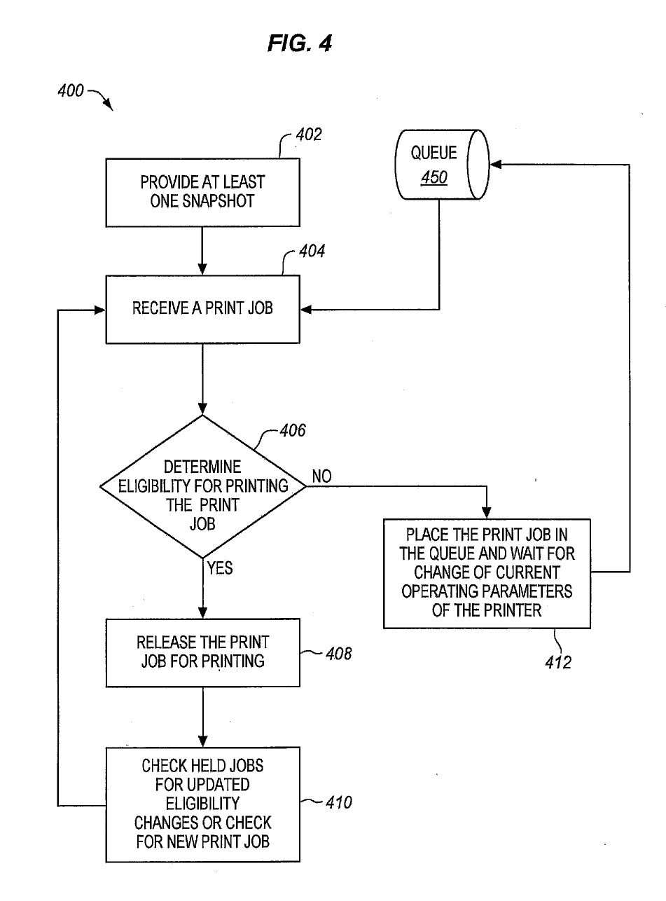

FIG. 4 is a flow chart illustrating an exemplary method 400 for operating a printing system. The steps of the flow chart in FIG. 4 are not all inclusive and may include other steps not shown.

In step 402, the printing system provides at least one snapshot, each snapshot including at least one printer setting for operating a printer. The snapshots may already be stored in memory, may be provided by a printer operator, may be provided with the print job, etc. The printer settings may further comprise eligibility criteria, indicating which of the printer settings of the snapshot is relevant to determining eligibility of the print job to print.

In step 404, the printing system may receive a print job. The print job may identify a snapshot to be used to determine whether the print job is eligible to be printed on the printer. If no snapshot is associated with the print job, then a predetermined snapshot may be associated with the print job. The predetermined snapshot may further comprise a snapshot corresponding to the current operating parameters of the printer may be associated with the print job. A next job may also be retrieved or received from the queue 450. The queue 450 may store newly received print jobs as well as held ineligible print jobs.

In step 406, the printing system determines eligibility for printing the print job based on at least one printer setting in a snapshot associated with the print job and based on at least one current operating parameter of the printer. The printer settings of the snapshot may indicate whether a particular printer setting is relevant to determining eligibility of the print job to print. To determine eligibility of the print job to print, the indicated printer settings relevant to eligibility may be considered, while the printer settings indicated as irrelevant to eligibility may be ignored. The print job may be determined ineligible to print if at least one of the indicated printer settings relevant to eligibility does not match the current operating parameters of the printer. Otherwise, if the current operating parameters of the printer match the indicated printer settings relevant to eligibility, then the print job may be printed. The printer settings indicated as irrelevant to eligibility may be ignored, so if a printer resource indicated by the snapshot is unavailable, the print job may still be eligible to print.

In step 408, if the print job is determined eligible to print, then the print job is released for printing. In step 410, after the print job is released for printing, the printing system may check the queue for held jobs that have updated eligibility and are now available for printing. The printing system may also wait for a new print job. The method may further include changing at least one current operating parameter of the printer, and determining eligibility for printing the print job that has not been released for printing based on at least one printer setting in the snapshot associated with the print job and based on at least one current operating parameter of the printer. If the print job is determined to be eligible to print, the print job is released for printing in step 408. The cycle begins again at step 404 once a new print job is received or an ineligible job becomes eligible for printing.

In step 412, if the print job is determined ineligible to print because at least one printer setting specified as relevant to determining eligibility in the snapshot associated with the print job, then the print job is held until the print job becomes eligible to print because of a change of the operating parameters of the printer.

Those of ordinary skill in the art will readily recognize a variety of techniques for choosing the next print job to be printed. For example, the printer may use a first in first out method, may use a job priority method, a source of job method, may always check ineligible jobs before printing new jobs, etc.

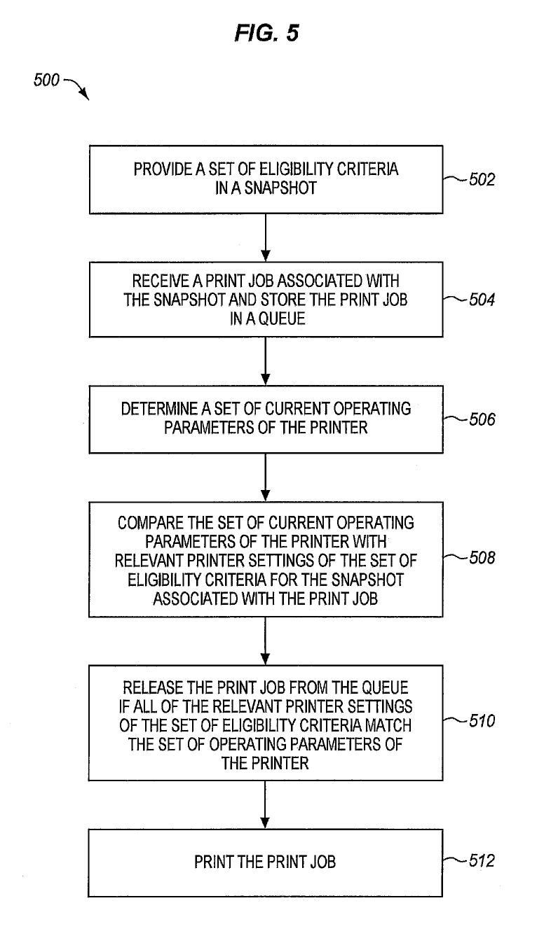

FIG. 5 is a flow chart illustrating an exemplary method 500 for operating a printing system. The steps of the flow chart in FIG. 5 are not all inclusive and may include other steps not shown.

In step 502, the printing system provides a set of eligibility criteria in a snap shot. The eligibility criterion comprise a printer setting, the set of eligibility criteria indicating whether the printer settings are relevant to determining the eligibility to print a print job associated with the snapshot. The printer settings that are relevant to determining the eligibility to print the print job comprise a relevant printer setting.

In step 504, the printing system receives a print job associated with the snapshot and stores the print job in a queue. In step 506, the printing system determines the set of current operating parameters of the printer.

In step 508, the printing system compares the set of current operating parameters of the printer with the set of eligibility criteria for the snapshot associated with the print job to determine if all of the relevant printer settings of the set of eligibility criteria match the set of current operating parameters of the printer.

In step 510, the print job is released from the queue if all of the relevant printer settings match the set of operating parameters of the printer. If all of the relevant printer settings do not match the set of operating parameters of the printer, then the print job is held in the queue. In step 512, responsive to releasing the print job from the queue, the print job is printed.

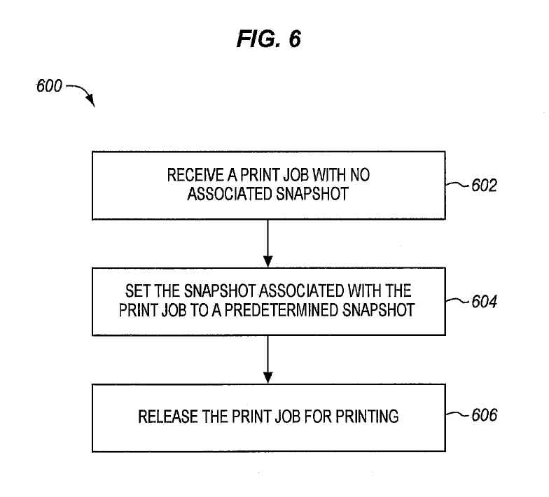

As noted above, in step 504, a print job is received with an associated snapshot. In some cases, the print job may not have an associated snapshot for the printing system to determine job eligibility. FIG. 6 is a flow chart illustrating a method 600 for operating a printing system when no snapshot is associated with a print job. The steps of the flow chart in FIG. 6 are not all inclusive and may include other steps not shown.

In step 602, the printing system receives a print job with no associated snapshot. In step 604, the snapshot associated with the print job is set to the snapshot corresponding to the set of current operating parameters of the printer (e.g., a predetermined or default snapshot). If a print job is received with no corresponding snapshot, then the print job may be ripped to the presently loaded snapshot of the continuous form printer and held in the queue. After the print job is ripped, the current operating parameters of the continuous form printer may change and may be no longer compatible with the print job. By associating a snapshot with the print job, the printer operator may restore the continuous form printer back to the printer settings that the print engine had when the print job came in and was ripped to so the print job may be printed. In step 606, the print job is released for printing.

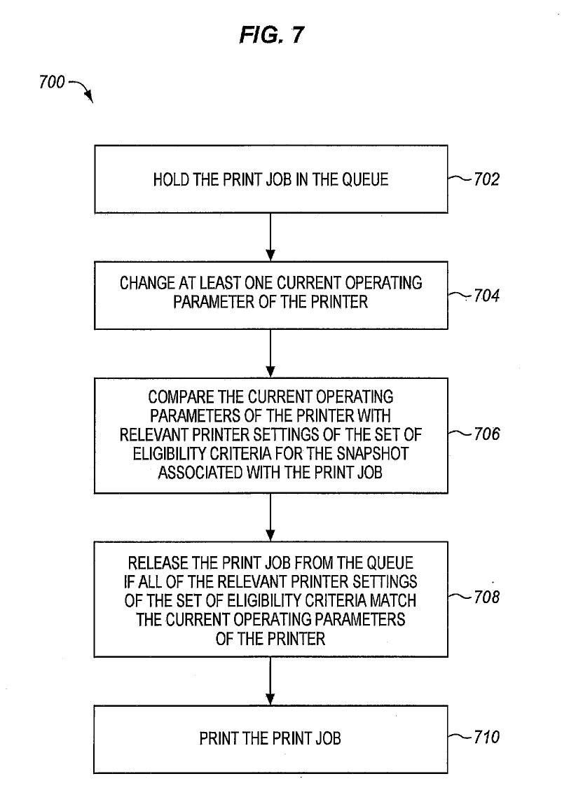

As noted above in method 500, a print job is released from the queue if all of the relevant printer settings of the set of eligibility criteria match the set of operating parameters of the printer. However, if the current operating parameters of the printer never change, a print job may always be determined ineligible. It may become necessary to change the current operating parameters of the printer to make a print job eligible to print. FIG. 7 is a flow chart illustrating a method 700 for operating a printing system when a print job has been held because the print job has been determined ineligible to print. The steps of the flow chart in FIG. 7 are not all inclusive and may include other steps not shown.

In step 702, the print job is held in the queue. In step 704, at least one current operating parameter of the printer is changed. The current operating parameters of the printer may be changed automatically by the printing system, or may be changed manually by a printing operator.

In step 706, the current operating parameters are compared with the relevant printer settings of the set of eligibility criteria for the snapshot associated with the print job.

In step 708, if all of the relevant printer settings of the snapshot associated with the print job match the current operating parameters of the printer, then the print job is released from the queue for printing. Otherwise, the print job is held in the queue if at least one of the relevant printer settings of the snapshot associated with the print job does not match the current operating parameters of the printer. The eligibility of the print job held in the queue may be periodically re-checked to determine if the print job has become eligible to print. In step 710, responsive to releasing the print job for printing, the print job is printed on the printer.

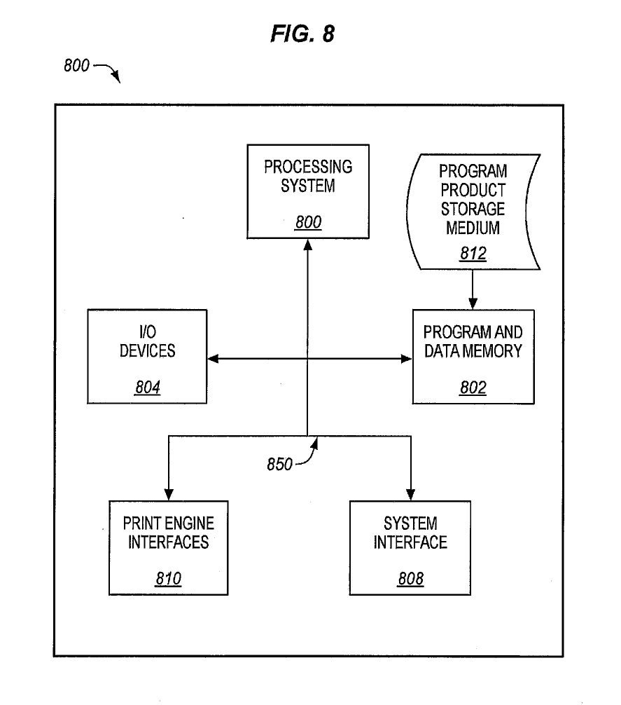

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc. FIG. 8 is a block diagram depicting a printer controller 100 as a data processing device adapted to provide features and aspects hereof by executing programmed instructions and accessing data stored on a computer readable storage medium 812.

Furthermore, the invention can take the form of a computer program product accessible from a computer-usable or computer-readable medium 812 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 800 coupled directly or indirectly to memory elements 802 through a system bus 850. The memory elements can include local memory employed during actual execution of the program code, bulk storage, and cache memories which provide temporary storage of at least some program code in order to reduce the number of times code must be retrieved from bulk storage during execution.

Input/output or I/O devices 804 (including but not limited to keyboards, displays, pointing devices, etc.) can be coupled to the system either directly or through intervening I/O controllers. One particular I/O device useful in a data processing system adapted as a printing system 100 is a print engine interface 810 for coupling the printing system 100 to the signals and protocols of the print engines adapted for marking pixels on paper.

Network adapters or other host system interfaces 808 may also be coupled to the system to enable the data processing system to become coupled to other data processing systems or storage devices through intervening private or public networks. Modems, cable modems, IBM Channel attachments, SCSI, Fibre Channel, and Ethernet cards are just a few of the currently available types of network or host interface adapters.

Although specific embodiments were described herein, the scope of the invention is not limited to those specific embodiments. The scope of the invention is defined by the following claims and any equivalents thereof.

We claim:

1. An apparatus in a printing system, the apparatus comprising:
at least one snapshot, each snapshot including at least one printer setting for operating a printer; and
a job eligibility checker communicatively coupled with the at least one snapshot and adapted to determine eligibility for printing a print job based on at least one printer setting in a snapshot associated with the print job and based on at least one current operating parameter of the printer, and adapted to release the print job for printing responsive to determining that the print job is eligible to be printed on the printer.

2. The apparatus of claim 1 wherein the at least one printer setting for operating the printer further comprises an eligibility criteria, the eligibility criteria indicating whether each printer setting is relevant to determining the eligibility to print the print job associated with the snapshot.

3. The apparatus of claim 1 wherein the print job identifies a snapshot to be used by the job eligibility checker to determine that the print job is eligible to be printed on the printer.

4. The apparatus of claim 1 further comprising a user interface communicatively coupled with the job eligibility checker, and adapted to allow a printer operator to manually release the print job for printing, and adapted to allow the printer operator to change the at least one current operating parameter of the printer.

5. The apparatus of claim 1 wherein the at least one current operating parameter of the printer are automatically changed to match the at least one printer setting in the snapshot associated with the print job received by the printing system.

6. The apparatus of claim 1 wherein the printer setting is selected from the group consisting of form settings, printer definitions, print quality, and print registration.

7. A method for operating a printing system, the method comprising:
providing at least one snapshot, each snapshot including at least one printer setting for operating a printer;
determining eligibility for printing a print job based on at least one printer setting in a snapshot associated with the print job and based on at least one current operating parameter of the printer; and
releasing the print job for printing responsive to determining that the print job is eligible to be printed on the printer.

8. The method of claim 7 wherein the print job identifies a snapshot to be used to determine that the print job is eligible to be printed on the printer.

9. The method of claim 7 wherein the at least one printer setting for operating the printer further comprises an eligibility criteria, the eligibility criteria indicating whether the printer setting is relevant to determining the eligibility to print the print job associated with the snapshot.

10. The method of claim 7 further comprising:
changing at least one current operating parameter of the printer; and
determining eligibility for printing the print job that has not been released for printing based on at least one printer setting in the snapshot associated with the print job and based on at least one current operating parameter of the printer.

11. The method of claim 7 wherein the printer setting is selected from the group consisting of form settings, printer definitions, print quality, and print registration.

12. The method of claim 7 further comprising setting the snapshot associated with the print job to a predetermined snapshot if no other snapshot is associated with the print job.

13. A method for operating a printing system, comprising:
providing a set of eligibility criteria in a snapshot, each eligibility criterion comprising a printer setting, the set of eligibility criteria indicating whether the printer setting is relevant to determining the eligibility to print a print job associated with the snapshot, the printer settings that are relevant to determining the eligibility to print the print job comprising a relevant printer setting;
receiving the print job associated with the snapshot and storing the print job in a queue;
determining a set of operating parameters of the printer;
comparing the set of operating parameters of the printer with the set of eligibility criteria for the snapshot associated with the print job to determine if all of the relevant printer settings of the set of eligibility criteria match the set of operating parameters of the printer;
holding the print job in the queue if at least one of the relevant printer settings does not match the set of operating parameters of the printer;
releasing the print job from the queue if all of the of the relevant printer settings match the set of operating parameters of the printer; and
printing the print job responsive to releasing the print job from the queue.

14. The method of claim 13 further comprising:
changing at least one current operating parameter of the printer; and
determining eligibility for printing the print job that has not been released for printing based on at least one printer setting in the snapshot associated with the print job and based on at least one current operating parameter of the printer.

15. The method of claim 13 wherein the printer setting is selected from the group consisting of form settings, printer definitions, print quality, and print registration.

16. The method of claim 13 further comprising setting the snapshot associated with the print job to a predetermined snapshot if no snapshot is associated with the print job.

17. A method for operating a printing system, the method comprising:
providing at least one snapshot, each snapshot including at least one printer setting for operating a printer; and
associating a snapshot with a print job based on information in the print job.

18. The method of claim 17 wherein the associating step further comprises:
determining the snapshot associated with the print job based on a named specific snapshot in the information in the print job.

19. The method of claim 17 wherein the associating step further comprises:
determining the snapshot associated with the print job based on a specific snapshot presently loaded on the printer at the time the print job is received by the printer.

20. The method of claim 17 wherein the associating step further comprises:
determining the snapshot associated with the print job based on a specific snapshot presently loaded on the printer at the time the print job is ripped by the printer.
